(19) United States
(12) Patent Application Publication
(10) Pub. No.: US 2009/0151134 A1
(43) Pub. Date: Jun. 18, 2009

(54) Apparatus for Fastening a Cover Profile for the Transition Between Two Surfaces Which Are Perpendicular With Respect to Each Other

(76) Inventor: Franz Neuhofer, JR., Zell am Moos (AT)

Correspondence Address: COLLARD & ROE, P.C., 1077 NORTHERN BOULEVARD, ROSLYN, NY, 11576, US

(21) Appl. No.: 12/085,790

(22) PCT Filed: Nov. 30, 2006
(86) PCT No.: PCT/AT2006/000495

§ 371 Date: Nov. 19, 2008

(30) Foreign Application Priority Data
Dec. 1, 2005 (AT) A 1937/2005

(51) Int. Cl. F16B 5/06; E04F 19/04

(52) U.S. Cl. 24/292; 52/288.1

(57) ABSTRACT

An apparatus is described for fastening a cover profile (4) for the transition between two surfaces (12, 13) which are perpendicular with respect to each other, comprising a support (1) which can be fastened to one of said surfaces (12, 13) and comprises two clamping legs (2, 3) for the cover profile (4) which extend in the longitudinal direction of the cover profile (4) and protrude against the cover profile (4), which profile can be mounted on the clamping legs (2, 3) under mutually opposite resilient contact of the clamping legs (2, 3) on the clamping surfaces (6) of the cover profile (4). In order to achieve a favorable clamping seat it is proposed that one of the two clamping legs (2, 3) carries a support leg (7) for the other clamping leg (3) which bulges forwardly against the cover profile (4) and that the support leg (7) which is pressurized by the cover profile (4) during the mounting of the cover profile (4) on the support (1) is displaceable either from an initial position holding the clamping legs (2, 3) in a straddled position to a position releasing the clamping legs (2, 3), or from an initial position for the mounting of the cover profile (4) to a clamping position pushing apart the clamping legs (2, 3).

### 1. FIELD OF THE INVENTION

The invention relates to an apparatus for fastening a cover profile for the transition between two surfaces which are perpendicular with respect to each other, comprising a support which can be fastened to one of said surfaces and comprises two clamping legs for the cover profile which extend in the longitudinal direction of the cover profile and protrude against the cover profile, which profile can be mounted on the clamping legs under mutually opposite resilient contact of the clamping legs on the clamping surfaces of the cover profile.

### 2. DESCRIPTION OF THE PRIOR ART

For simply fastening cover profiles in the transition region between two mutually perpendicular surfaces, especially skirting boards, it is known (DE 101 07 864 A1) to provide supports which form two resilient clamping legs which protrude from a wall leg against the cover profile and which comprise hook-like edge folds and engage with said edge folds under resilient pretension into undercut recesses of the cover profile. The support per se grasps with a floor leg a floor covering, by which it is kept pressed against the wall by means of laterally applied leaf springs. The disadvantageous aspect is especially that the dimensions of the clamping legs with the hook-like edge folds and the position of the recesses of the cover profile for receiving the clamping legs need to be adjusted precisely with respect to each other in order to ensure play-free and secure fastening of the cover profile. The same applies when the support is screwed onto the wall and comprises three clamping legs with hook-like noses which protrude against the cover profile (DE 101 07 866 A1), because in this case too the pretension for the resilient clamping seat of the clamping legs on the clamping surfaces of the recesses cannot be chosen to a sufficiently large extent due to the alignment of the clamping legs relative to the groove-like recesses in the profile which are required for inserting the cover profile on the clamping legs.

### SUMMARY OF THE INVENTION

The invention is thus based on the object of arranging an apparatus for fastening a cover profile for the transition between two mutually perpendicular surfaces of the kind mentioned above with simple constructional means in such a way that a comparatively high clamping force can be ensured without having to avoid toolless mounting of the cover profile on the support.

This object is achieved by the invention in such a way that one of the two clamping legs carries a support leg for the other clamping leg which bulges forwardly against the cover profile and that the support leg which is pressurized by the cover profile during the mounting of the cover profile on the support is displaceable either from an initial position holding the clamping legs in a straddled position to a position releasing the clamping legs, or from an initial position for the mounting of the cover profile to a clamping position pushing apart the clamping legs.

By providing a support leg which originates from one of the two clamping legs and cooperates with the other, the two clamping legs can be held in a mutual distance which is advantageous for the mounting of the cover profile as a pre-condition for advantageous handling, irrespective of the pretension to be respectively applied. Two cases can be distinguished. When the two clamping legs are held in their initial position by the support leg under pretension in a straddled position, then it is sufficient to displace the support leg from a latched position defining the initial position in order to release the two clamping legs which then, as a result of the pretension of the spring linked with the straddled position, press on the clamping surfaces of the cover profile with a respective clamping force. The other possibility is to move the two clamping legs apart from the initial position when displacing the support leg during the mounting of the cover profile on the clamping legs, so that the resilient clamping forces are built up only by the straddling process. In both cases it is possible to ensure in the initial position the required alignment of the clamping legs of the support relative to the clamping surfaces to be grasped behind, which occurs irrespective of the clamping forces that act during the clamping seat. It is merely necessary to ensure a respective displacement of the support leg, which does not pose any problems due to the bulging of the support leg against the cover profile. When the cover profile is mounted on the clamping legs of the support, the cover profile is pressed against the bulging of the support leg and the same is swivelled under sliding motion along the adjacent clamping leg against the clamping leg forming or supporting the same.

In order to release the two clamping legs which are straddled in the initial position under resilient pretension, the clamping leg which rests in a sliding manner on the support leg in the straddled initial position can comprise a receiving recess for the support end of the support leg on the side of the support leg averted from the cover profile, so that the support leg will slide from its latched position against the receiving recess and engage in the same when it is pressurized by the cover profile, with the supporting effect being lost and the clamping legs being resilient against the clamping surfaces of the cover profile.

Although the arrangement of the support leg can be made in such a way that no latching is necessary against the adjacent clamping leg in the straddled initial position, the support leg can engage in the initial position into a notch of the adjacent clamping leg, through which the initial position of the two clamping legs of the support is determined additionally in a constructional respect.

### BRIEF DESCRIPTION OF THE DRAWING

The subject matter of the invention is shown by way of example in the drawings, wherein:

FIG. 1 shows a schematic sectional view of an apparatus in accordance with the invention for fastening a cover profile for the transition between two mutually perpendicular surfaces prior to the mounting of the cover profile on the support;

FIG. 2 shows the apparatus according to FIG. 1 after the mounting of the cover profile on the support;

FIGS. 3 and 4 show an illustration of an embodiment in accordance with FIGS. 1 and 2 of a fastening apparatus in accordance with the invention;

FIGS. 5 and 6 show a further constructional variant of an apparatus in accordance with the invention in an illustration corresponding to FIGS. 1 and 2;

FIGS. 7 and 8 show a constructional variant of a fastening apparatus as shown in FIGS. 3 and 4;

FIG. 9 shows an additional embodiment of a fastening apparatus in accordance with the invention for a cover profile in a schematic sectional view prior to the mounting of the cover profile;

FIG. 10 shows the apparatus according to FIG. 9 after the mounting of the cover profile, and

FIGS. 11 and 12 show an embodiment of a fastening apparatus according to the FIGS. 9 and 10.

### DESCRIPTION OF THE PREFERRED EMBODIMENTS

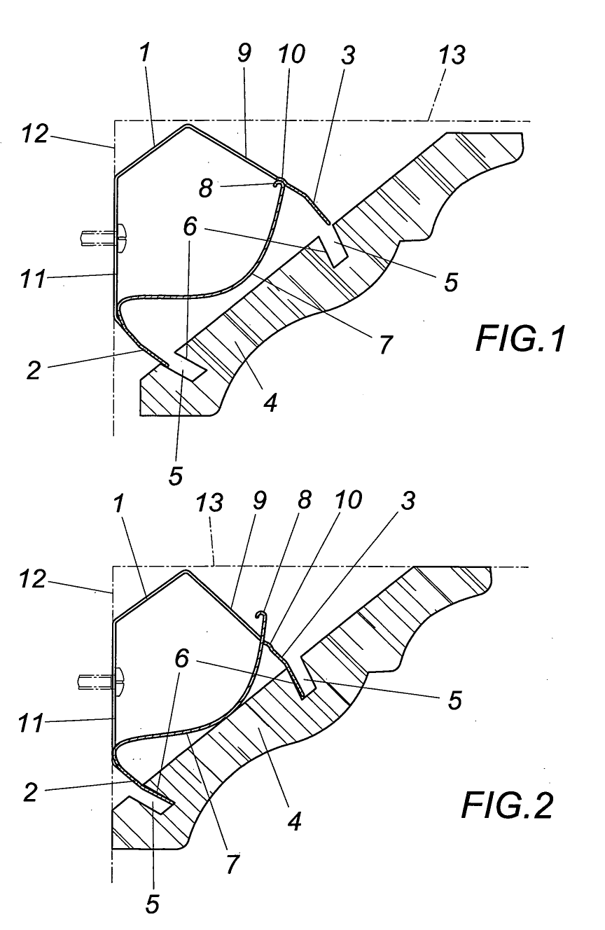

The support 1 according to the embodiment according to FIGS. 1 and 2 comprise two clamping legs 2, 3 on which a cover profile 4 can be mounted. For this purpose, the cover profile 4 forms two longitudinal grooves 5 whose mutually facing walls form undercut clamping surfaces 6. Clamping leg 2 carries a support leg 7 whose free support end 8 rests on the clamping leg 3 in the initial position of support 1 as shown in FIG. 1 and holds the same in a straddled position under resilient pretension. On the side of the support leg 7 which is opposite of the cover profile 4, the clamping leg 3 comprises a receiving recess 9 for the support leg 7. The latched position of the support leg 7 as shown in FIG. 1 which bulges against the cover profile 4 can be secured by a notch 10 provided in the clamping leg 3.

The support 1 is fastened by means of a fastening web 11 on one of two mutually perpendicular surfaces 12, 13. This occurs according to the embodiment according to FIGS. 1 and 2 on the surface 12 of a wall in a room close to the surface 13 formed by the ceiling of the room. The cover profile 4 thus forms a cornice strip. Since the clamping legs 2, 3 are aligned in the initial position according to FIG. 1 in the direction of the longitudinal grooves 5 of the cover profile 4, the cover profile 4 can easily be mounted on the clamping legs 2, 3 of the support 1. The cover profile 4 presses against the support leg 7 which slides from the optionally provided notch 10 to the receiving recess 9 and releases the clamping leg 2, 3 upon engagement in the receiving recess 9. As a result of this release, the clamping legs 2, 3 are resiliently pressed against the clamping surfaces 6 of cover profile 4, thus leading to a clamping seat for the cover profile 4 which allows secure contact of the cover profile 4 on both surfaces 12, 13. Due to the support leg 7 which pushes apart the two clamping legs 2, 3, an advantageous pretension for the resilient clamping legs 2, 3 can be ensured without having to accept any complex handling.

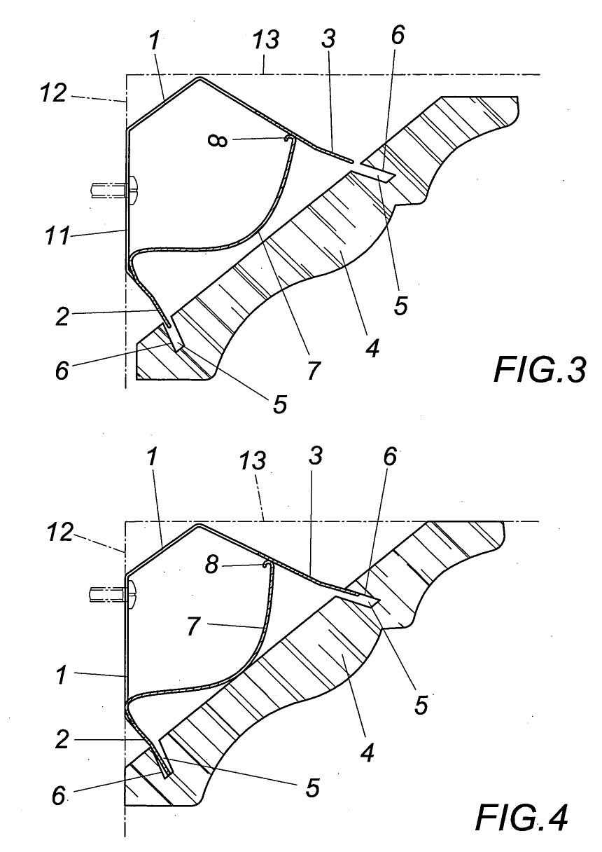

The embodiment according to FIGS. 3 and 4 differs from the one according to FIGS. 1 and 2 in such a way that the pretension of the clamping legs 2, 3 is achieved by pushing apart said clamping legs 2, 3 with the help of the support leg 7. Clamping legs 2, 3 are held aligned relative to the longitudinal grooves 5 by the support legs 7 in the initial position as shown in FIG. 3 in order to ensure the simple mounting of the cover profile 4 on the clamping legs 2, 3 in the support 1. The pressuring of the support legs 7 by the cover profile causes the clamping legs 2, 3 to be pushed apart however, because in the area of the support end 8 of the support leg 7 there is no receiving recess of the clamping leg 3. The clamping legs are pressed against the clamping surfaces 6 which face away from one another, as is shown in FIG. 4. The clamping force is ensured by the support leg 7 which is held by the cover profile 4 in the straddled position causing the pretension of the clamping legs 2, 3.

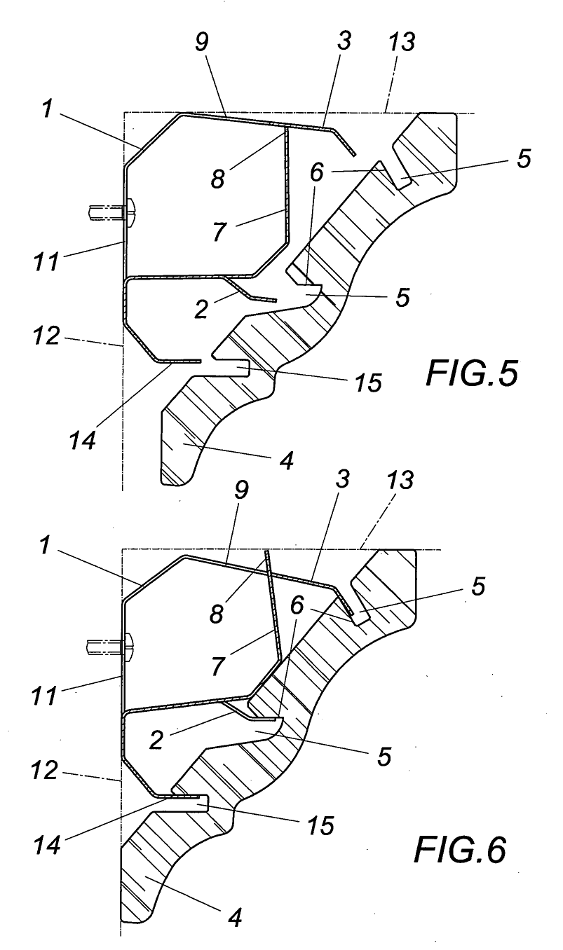

According to FIGS. 5 and 6, support 1 further comprises an additional holding web 14 which cooperates with a further longitudinal groove 15 of the cover profile 4 and additionally fixes the cover profile 4 in its position of height. Said holding web 14 is a part of the fastening web 11 and remains unaffected by the resilient pushing apart of the clamping legs 2, 3. To ensure that the support 1 can be made from a sheet-metal blank, the support leg 7 must be punched out of the fastening web 11 and be bent out accordingly, with the clamping leg 2 either being punched and bent out as a middle tongue from the support leg 7 or, as shown in FIGS. 5 and 6, it needs to be formed by lateral noses of the support leg 7. In all other respects, the clamping legs 2, 3 cooperate correspondingly like the clamping legs 2, 3 according to the embodiment of FIGS. 1 and 2.

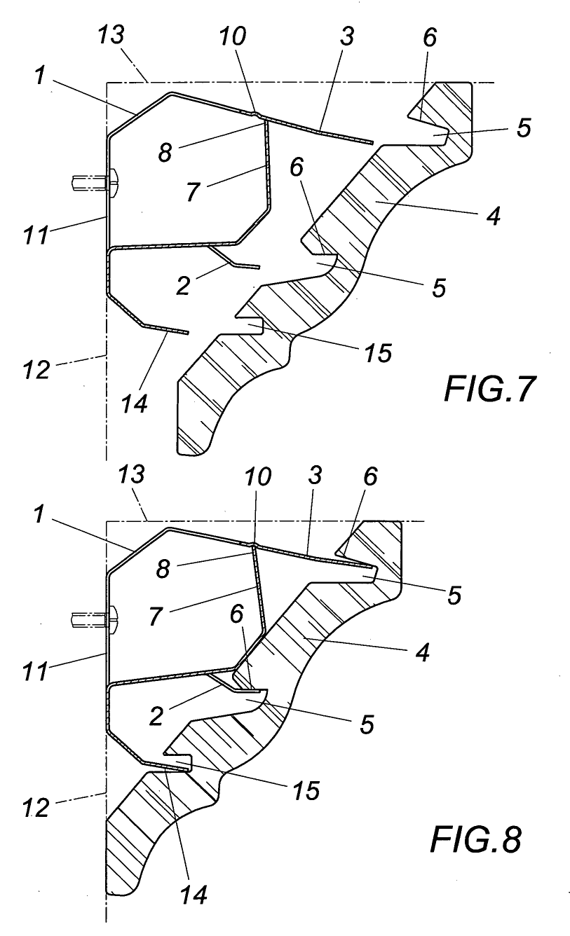

The fastening apparatus according to FIGS. 7 and 8 corresponds to the apparatus as shown in FIGS. 5 and 6 concerning the additional holding web 14 which engages in a separate groove 15 of the cover profile 4. The clamping legs 2 and 3 are pushed apart with the help of the support leg 7 during the mounting of the cover profile 1 on the support 1 according to the constructional variant according to FIGS. 3 and 4, with a clamping engagement of the clamping legs 2, 3 being obtained in the longitudinal grooves 5.

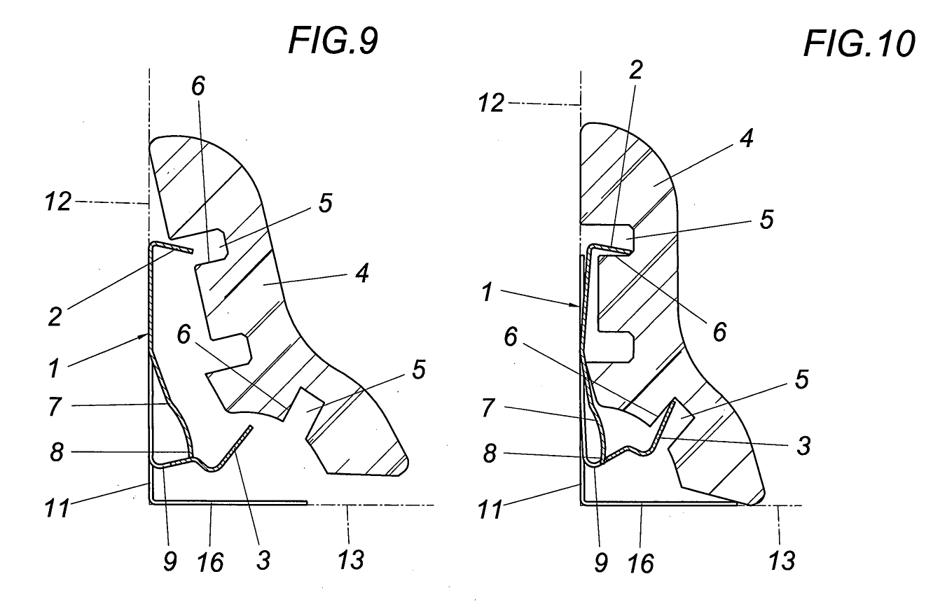

According to the embodiment according to FIGS. 9 and 10, the cover profile 4 is formed by a skirting board. Accordingly, the two surfaces 12, 13 represent the wall of a room and a floor. In order to fix the support 1 with the clamping legs 2 and 3 at a predetermined height above the surface 13 of the floor, the fastening web 11 forms a bent foot 16 through which the support 1 can rest on the floor. The support leg 7 connected with the clamping leg 2 cooperates with the clamping leg 3 and holds the two clamping legs 2 and 3 in the pretensioned straddled position, as is shown in FIG. 9. When the cover profile 4 is mounted on the support 1, the support leg 7 is pressed into the receiving recess 9 of the clamping leg 3, through which the clamping legs 2 and 3 are released, as has already been explained in connection with the FIGS. 1 and 2. The cover profile 4 is thus fixed via the clamping legs 2 and 3 which engage in the longitudinal grooves 5 of the cover profile 4 and rest on the clamping surfaces 6 formed by the groove walls.

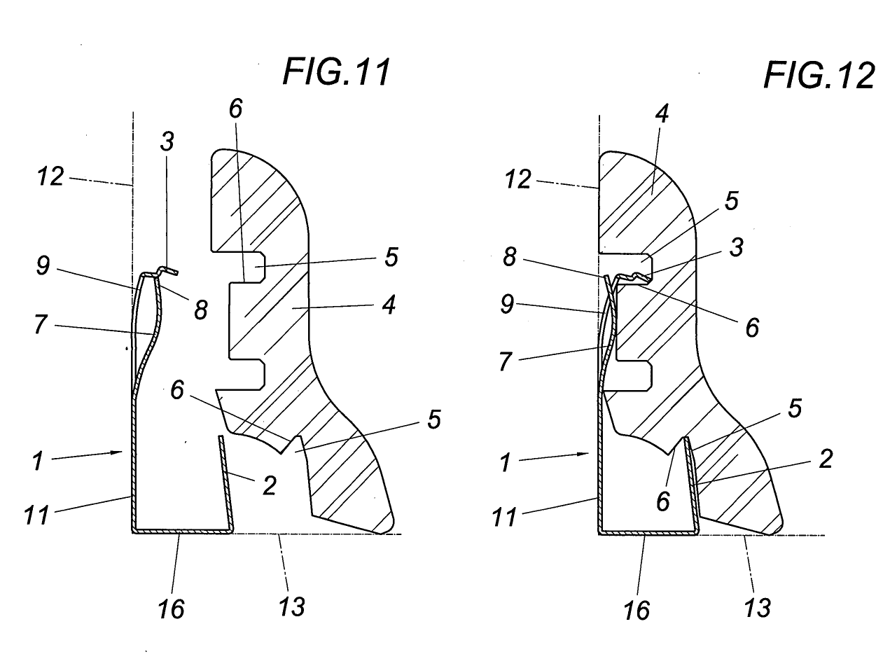

As can be seen directly from FIGS. 9 and 10, the space which is obtained between the surfaces 12 and 13 and the cover profile 4 and which can be used for laying lines is narrowed considerably by the bottom clamping leg 3. In order to avoid this limitation, the resilient leg 3 can be moved upwardly, as is shown in the FIGS. 11 and 12. The operating principle of support 1 principally remains the same because the support leg 7 which holds the clamping leg 3 in the straddled position is displaced against the receiving recess 9 during the mounting of the cover profile 4, so that after the engagement of the support leg end 8 in receiving recess 9 the clamping leg 3 is pressed in a resilient manner against the clamping surface 6 of the longitudinal groove 5 and the cover profile 4 is tightly held in a clamping manner between the clamping legs 2 and 3. Due to the displacement of the clamping leg 3 which is held by the support leg 7 in the straddled position to the wall area formed by the surface 12, the clamping leg 2 which is carried by the fastening web 11 can enclose the space used for laying lines, so that support 1 will not impair the laying of lines, as can clearly be seen in FIG. 12.

1. An apparatus for fastening a cover profile (4) for the transition between two surfaces (12, 13) which are perpendicular with respect to each other, comprising a support (1) which can be fastened to one of said surfaces (12, 13) and comprises two clamping legs (2, 3) for the cover profile (4) which extend in the longitudinal direction of the cover profile (4) and protrude against the cover profile (4), which profile can be mounted on the clamping legs (2, 3) under mutually opposite resilient contact of the clamping legs (2, 3) on the clamping surfaces (6) of the cover profile (4), wherein one of the two clamping legs (2, 3) carries a support leg (7) for the other clamping leg (3) which bulges forwardly against the cover profile (4) and that the support leg (7) which is pressurized by the cover profile (4) during the mounting of the cover profile (4) on the support (1) is displaceable either from an initial position holding the clamping legs (2, 3) in a straddled position to a position releasing the clamping legs (2, 3), or from an initial position for the mounting of the cover profile (4) to a clamping position pushing apart the clamping legs (2, 3).

2. An apparatus according to claim 1, wherein the clamping leg (3) which rests in a sliding manner on the support leg (7) in the straddled initial position comprises a receiving recess (9) for the support end (8) of the support leg (7) on the side of the support leg (7) averted from the cover profile (4).

3. An apparatus according to claim 1, wherein the support leg (7) engages in a notch (10) of the adjacent clamping leg (3) in the initial position.
